(19) United States
(12) Patent Application Publication
(10) Pub. No.: US 2015/0125596 A1
(43) Pub. Date: May 7, 2015

(54) INK COMPOSITION FOR MANUFACTURE OF HIGH RESOLUTION CONDUCTING PATTERNS

(71) Applicant: UNIPIXEL DISPLAYS, INC., The Woodlands, TX (US)

(72) Inventors: Ed S. Ramakrishnan, The Woodlands, TX (US); Danliang Jin, The Woodlands, TX (US)

(21) Appl. No.: 14/400,272

(22) PCT Filed: Mar. 12, 2013
(86) PCT No.: PCT/US2013/030591

§ 371 Date: Nov. 10, 2014

Related U.S. Application Data
(60) Provisional application No. 61/646,032, filed on May 11, 2012.

(51) Int. Cl. C09D 11/107; C08K 5/098; B41F 5/24; H01Q 1/22; H01Q 7/00

(52) U.S. Cl. CPC C09D 11/107; H01Q 1/2225; H01Q 7/00; B41F 5/24; C08K 5/098
USPC 427/125; 427/58; 427/126.1; 427/123

(57) ABSTRACT

Systems and methods of flexographically printing a pattern comprising a plurality of lines or a first antenna loop array on a first side of a substrate, wherein printing the first antenna loop array comprises using an ink and at least one flexomaster. The ink comprises an acrylic monomer resin and a catalyst which may be an organometallic acelate or oxolate at a concentration from 1 wt %-20 wt %. The substrate may have one pattern on one surface of the substrate or may be printed as a double-sided substrate with at least one pattern on each side of the substrate. The ink is cured to dissociated the catalyst in the ink prior to electroless plating, this may be done using one curing process on each side, using one curing process in total, or by performing a partial cure on a first pattern and then curing the second pattern.

### CROSS-REFERENCE TO RELATED APPLICATIONS

The present application claims priority to U.S. Provisional Patent Application No. 61/646,032 filed May 11, 2012.

### FIELD OF THE DISCLOSURE

This disclosure relates generally to the printing of high resolution conducting patterns, specifically to roll to roll manufacturing processes for high resolution conducting patterns.

### BACKGROUND

Conventional methods of manufacturing transparent thin film antennas and other conductive patterns that may be used in electronics or other industries comprise screen printing employing a thick film with conductive paste of copper/silver, resulting in wide (>100 μm) and tall (>10 μm) lines. Photolithography and etching processes are used for thinner and narrower features.

### SUMMARY

In an embodiment, a method of flexographically printing an RFID antenna comprises: printing a first antenna loop array on a first side of a substrate, wherein printing the first antenna loop array comprises using an ink and a first flexomaster, wherein the ink comprises an acrylic monomer resin and a catalyst, wherein the catalyst is at a concentration from 1 wt. %-20 wt. %, and wherein the catalyst comprises a plurality of organometallic particles; curing the substrate by dissociating the catalyst in the ink.

In an alternate embodiment, a method of flexographically printing an RFID antenna comprises: printing a first antenna loop array on a first side of a substrate using an ink and a first flexomaster; partially curing the first antenna loop array; printing a second antenna loop array on a second side of the substrate using the ink and a second flexomaster; and completely curing the second antenna loop array; wherein the ink comprises an acrylic monomer resin and a catalyst, wherein the catalyst is at a concentration below 6%, and wherein the catalyst comprises a plurality of organometallic particles.

In an embodiment, an alternate method of printing a high resolution conductive pattern comprising: printing, using a flexographic printing process, a first pattern comprising a first plurality of lines on a first substrate using a first flexomaster and an ink comprising an acrylic monomer resin and a catalyst; printing, using the flexographic printing process, a second pattern comprising a second plurality of lines using a second flexomaster and the ink, wherein each line of the first plurality of lines and each line of the second plurality of lines are 1-25 microns wide; and curing the first and the second patterns.

### BRIEF DESCRIPTION OF THE DRAWINGS

For a detailed description of the exemplary embodiments of the invention, reference will now be made to the accompanying drawings in which

FIG. 1 depicts illustrations of isometric views of flexoplates according to embodiments of the disclosure.

FIGS. 2A and 2B are illustrations transparent single and multi-loop RF antennae according to embodiments of the disclosure.

FIG. 3 is an illustration of a method of printing high resolution patterns on a substrate according to embodiments of the disclosure.

FIG. 4 is a flow chart of a method of printing high resolution patterns on a substrate according to embodiments of the disclosure.

FIG. 5 is a flow chart of an alternate method of printing high resolution patterns on a substrate according to embodiments of the disclosure.

### DETAILED DESCRIPTION

The present disclosure relates to a method of roll to roll printing of high resolution conducting patterns. The method generally utilizes a polymer ink used to define a pattern that is subsequently electroless plated. The polymer ink, which may be UV-curable, may be used as part of a flexographic manufacturing process. Discussed herein are methods and systems for dissolving metal acetate particles directly into the polymer resin ink that will be employed in a printing process such as flexographic printing. In certain instances, the ink comprises palladium or a similar catalyst as an acetate or oxalate salt. The polymer ink may be an acrylic ink or similar polymer. Additionally, certain ink formulations may comprise organometallic compounds. In certain methods, ultrasonic stirring during dissolution of the organometallic acetate particles and other materials directly into the polymeric ink are used for the printing. These organometallic materials may not be ready for electroless plating after printing and may require activation, for example, in the form of curing. As such, these organometallic compounds are treated by ultraviolet light, heat, or other means to convert the compounds in the printed pattern to their elemental metal form by dissociating the catalytic compound through exposure to ultraviolet radiation until the dissociation is completed. The electroless plating process may be conducted in a water-based chemical bath, where copper (Cu), nickel (Ni), tin (Sn), gold (Au), silver (Ag) or other metallic—salt based chemicals are present.

As found herein, method of the present disclosure provides for the fabrication of micro circuitries that may be printed on one side or both sides of a suitable substrate, with high uniformity, high integrity, and a printed line width below about 25 microns, preferably below 5 microns. Further, the printed micro-circuitries of the present invention may be manufactured without utilizing chemical etching or other ablative techniques that provide potential sources of contamination.

### Roll-to-Roll Manufacturing Process

Flexography is a form of a rotary web letterpress where relief plates are mounted on to a printing cylinder, for example, with double-sided adhesive. These relief plates, which may also be referred to as a master plate or a flexoplate, may be used in conjunction with fast drying, low viscosity solvent, and ink fed from anilox or other two roller inking system. The anilox roll may be a cylinder used to provide a measured amount of ink to a printing plate. The ink may be, for example, a water-based or ultraviolet (UV)-curable ink. In one example, a first roller transfers ink from an ink pan or a metering system to a meter roller or anilox roll. The ink is metered to a uniform thickness when it is transferred from the anilox roller to a plate cylinder. When the substrate moves through the roll-to-roll handling system from the plate cylinder to the impression cylinder, the impression cylinder applies pressure to the plate cylinder which transfers the image on to the relief plate to the substrate. In some embodiments, there may be a fountain roller instead of the plate cylinder and a doctor blade may be used to improve the distribution of ink across the roller.

Flexographic plates may be made from, for example, plastic, rubber, or a photopolymer which may also be referred to as a UV-sensitive polymer. The plates may be made by laser engraving, photomechanical, or photochemical methods. The plates may be purchased or made in accordance with any known method. The preferred flexographic process may be set up as a stack type where one or more stacks of printing stations are arranged vertically on each side of the press frame and each stack has its own plate cylinder which prints using one type of ink and the setup may allow for printing on one or both sides of a substrate. In another embodiment, a central impression cylinder may be used which uses a single impression cylinder mounted in the press frame. As the substrate enters the press, it is in contact with the impression cylinder and the appropriate pattern is printed. Alternatively, an inline flexographic printing process may be utilized in which the printing stations are arranged in a horizontal line and are driven by a common line shaft. In this example, the printing stations may be coupled to curing stations, cutters, folders, or other post-printing processing equipment. Other configurations of the flexographic process may be utilized as well.

In an embodiment, flexoplate sleeves may be used, for example, in an in-the-round (ITR) imaging process. In an ITR process, the photopolymer plate material is processed on a sleeve that will be loaded on to the press, in contrast with the method discussed above where a flat plate may be mounted to a printing cylinder, which may also be referred to as a conventional plate cylinder. The flexo-sleeve may be a continuous sleeve of a photopolymer with a laser ablation mask coating disposed on a surface. In another example, individual pieces of photopolymer may be mounted on a base sleeve with tape and then imaged and processed in the same manner as the sleeve with the laser ablation mask discussed above. Flexo-sleeves may be used in several ways, for example, as carrier rolls for imaged, flat, plates mounted on the surface of the carrier rolls, or as sleeve surfaces that have been directly engraved (in-the-round) with an image. In the example where a sleeve acts solely as a carrier role, printing plates with engraved images may be mounted to the sleeves, which are then installed into the print stations on cylinders. These pre-mounted plates may reduce changeover time since the sleeves can be stored with the plates already mounted to the sleeves. Sleeves are made from various materials, including thermoplastic composites, thermoset composites, and nickel, and may or may not be reinforced with fiber to resist cracking and splitting. Long-run, reusable sleeves that incorporate a foam or cushion base are used for very high-quality printing. In some embodiments, disposable “thin” sleeves, without foam or cushioning, may be used. Flexographic printing processes may use anilox rolls for ink transfer as a means of metering the ink so that the ink prints the desired pattern with clear, uniform features free of clumping or smearing.

High resolution conducting pattern circuitry may be manufactured by means of a roll-to-roll manufacturing process. The process may comprise activating an electroless plating catalyst contained in the polymer ink. This may be achieved by means of ultraviolet ionizing radiation curing or thermal treatment of the printed patterns of line width as narrow as 1 micron. This process utilizes ultrasonic stirring action to dissolve metal acetate particles directly into the acrylic base polymer ink employed for printing high definition conductive electrodes required for multiple electronic applications The ink making process may utilize ultrasonic agitation to dissolve metal acetate particles directly into the acrylic base polymer ink or other biding resins. These inks are used for printing high definition conductive electrodes required for multiple electronic applications including RF antenna structures and arrays, as well as microscopic high resolution patterns used in touch screens such as capacitive and resistive touch screen sensors.

To initiate the roll to roll manufacturing process, the transparent flexible substrate may be transferred via any known roll to roll handling method from unwind roll to a first cleaning station. It is appreciated that the thickness of transparent flexible substrate may be chosen in combination with a plurality of process parameters such as line speed and pressure in order to avoid excessive tension during the printing process resulting in dimensional changes by elongation. Temperature-induced dimensional changes may be considered as well since any such changes to temperature may result in changes to the printed dimensions.

The alignment and printing of transparent high resolution conducting patterns may impact the final product performance. In this embodiment a positioning cable may be employed to maintain the alignment of and guide a transparent flexible substrate to a first cleaning at a first cleaning station that comprises a high electric field ozone generator employed to remove impurities, for example oils or grease from the transparent flexible substrate. The transparent flexible substrate may then undergo a second cleaning at second cleaning station, which may be a web cleaner.

After the second cleaning at second cleaning station, the transparent flexible substrate may go through a first printing station where a high resolution conducting pattern (HRCP) is printed. The high resolution conducting pattern may comprise, for example, a plurality of lines for a touch screen circuit, or circuitry for a planar, dipole, transparent single loop antenna circuitry on a first surface of the transparent flexible substrate. The amount of ink transferred from the first master plate to the transparent flexible substrate may be regulated by a high precision metering system, and may depend on the speed of the process, the ink composition, as well as the shape and dimensions of the high resolution pattern (HRP).

The pattern printed at the first printing station may be, for example, a single antenna loop. Conventionally, multiple curing steps may be required in order to activate the ink after the pattern is printed at the first printing station prior to the plating process described below. If the catalyst is underexposed, the dissociation of the organometallic catalyst will be incomplete and the plating process will be impaired. However, if the substrate is overexposed, it may embrittle and compromise the integrity of the finished product, or render the substrate unsuitable for further processing. In some embodiments, laser irradiation at 126 nm, 172 nm or 193 nm may produce similar effects but may not produce the desired surface quality of the resultant plated films.

In another embodiment, if the pattern printed at the first printing station is a planar, dipole, low visibility single antenna circuitry, then a second planar, dipole, low visibility multiple loops antenna circuitry pattern may be printed a at second printing station on the bottom side of the transparent flexible substrate. The bottom side of the transparent flexible substrate might pass through a second printing station which is done by a second master plate that may use a palladium acetate ink to print the multiple loops antenna circuitry on the bottom side of the transparent flexible substrate. The amount of ink transferred from a second master plate to the bottom side of the transparent flexible substrate may also be regulated by a second high precision metering system. In some embodiments, a plurality of flexoplates may be used in at least one of the first or the second printing stations. In those embodiments, there may be a plurality of inks used for each flexoplate of the plurality of flexoplates depending upon the shape and geometry of the patterns printed at the first and the second printing stations.

The bottom side printing at the second printing station may be followed by a second curing station. The second curing station may comprise a second ultraviolet radiation cure as described above, with the about same target intensity, and at about the same wave length. The second curing station may be used so that the catalyst in the ink is not underexposed, as underexposure may impede the plating process. In addition, the second curing station may comprise a second oven heating module that applies heat within a temperature range of about 20° C. to about 85° C.

### Electroless Plating

The first and the second patterns printed on the top and the bottom (or first and second) sides of the substrate may be a single loop antenna circuitry printed on the top (first) surface of the transparent flexible substrate and a plurality of loops of an antenna circuitry printed on the bottom (second) surface of the substrate. In one example, both patterns may be printed with palladium (Pd) acetate or other catalyst-based ink. For example, other organometallics may be used that are acetates or oxalates of palladium, rhodium, platinum, copper, or nickel. This ink may contain a plating catalyst that is employed to define the conductive pattern circuitry patterns printed at the first and second printing stations. The entire substrate that contains both patterns may then undergo electroless plating at a plating station. During plating, the seed catalyst acts as a receptor and enables the plating metal (for example, copper, nickel, palladium, aluminum, silver, and gold) to grow to a desired thickness or range of thickness of the plated coating. In some embodiments, organometallic materials such as Pd acetate or Pd oxalate may not be ready to plate and may have further treatment to convert the compounds in the printed pattern to their metal form. Further treatment may be performed because the activation of the ink means that the palladium acetate is dissociated from non-metallic form to metallic form. The further treatment may comprise dissociating the compounds through exposure to ultraviolet radiation with a broad spectrum, the wave length used may be maintained between about 365 nm and about 435 nm. As discussed above, if the catalyst is underexposed, i.e., not sufficiently dissociated, the electroless plating process may be impaired and the pattern may not be plated properly, uniformly, or completely.

Depending upon the composition of the ink, the activation process may not maintain the integrity of the pattern and, therefore, the printed pattern and the plated pattern may not have the same dimensions, a problem that may be more pronounced where the printed patterns have small dimensions. However, subsequent curing processes may not be needed if the concentrate of the organometallic is between 1 wt. %-20 wt. %, preferably between 1 wt. %-5 wt. %, and if the parameters used for the first curing step are sufficient to cure the printed pattern when the organometallic ink is used. It is appreciated that the curing parameters may be conformed by the substrate properties, for example, if the pattern or patterns are cured for too long, or if one pattern is printed and cured and a second pattern is printed and cured, the same substrate may be cured twice under two full curing cycles or processes. As a result, the substrate may embrittle and/or experience discoloration and therefore may not maintain its desired properties such as flexibility, transparency, and strength. The curing time may vary depending upon the organometallic content (wt %) of the ink. A higher percentage of organometallics may result in a more intense curing to dissociate the organometallic. In that scenario, in addition to ultraviolet curing, the organometallics may be dissociated by a heat cure. This dissociation may occur upon what is referred to as the activation of the organometallic compound. Activation is when the organometallic, such as Pd acetate, is dissociated from the compound form to metallic form and the metallic form becomes conductive for (and thereby responsive to) plating. It is appreciated that, even though the ink dissociates, the dissociation takes place inside the ink so the ink as printed does not experience dimensional distortion, which preserves the as-printed pattern dimensions and uniformity for the plating process.

After printing the top and, in some cases, bottom patterns on the transparent flexible substrate, the patterns, for example, antenna patterns, may be plated by submerging the single loop antenna circuitry that may be printed on the top side of the substrate at the first printing station and the plurality of loops of the antenna circuitry printed on the bottom side of the substrate at printing station into an electroless plating tank at a plating station that contains copper or other conductive material. The thickness of the plated pattern may depend on the plating solution temperature and the speed of the web which may be varied according to the application. The electroless plating at the plating station does not require the application of electrical current and only plates the patterned areas containing a plating catalyst that were previously activated through ionizing ultraviolet radiation curing exposure. Thus may be faster than achievable by thermal means heat curing. The plating thickness may be more uniform compared to electroplating due to the absence of electric fields. Electroless plating may be well suited for parts with complex geometries and/or many features, like those exhibited by printed transparent antenna patterns circuitries.

After electroless plating, the flexible substrate with both patterns, may go through a washing process comprising submerging the RF antenna circuitries into a cleaning tank that contains deionized water at room temperature or at a higher temperature (<70° C.). The RF antenna circuitries may be subsequently dried at a drying station by applying air at room temperature or a higher temperature (<70° C.). To protect the conductive material of the RF antenna circuitries against corrosion, a passivation station may be used to passivate the substrate. The passivation station may comprise a spray or an immersion in a passivating chemical may be added after drying to prevent any undesired reaction between the conductive materials and contaminants in the environment such as moisture, organic vapors.

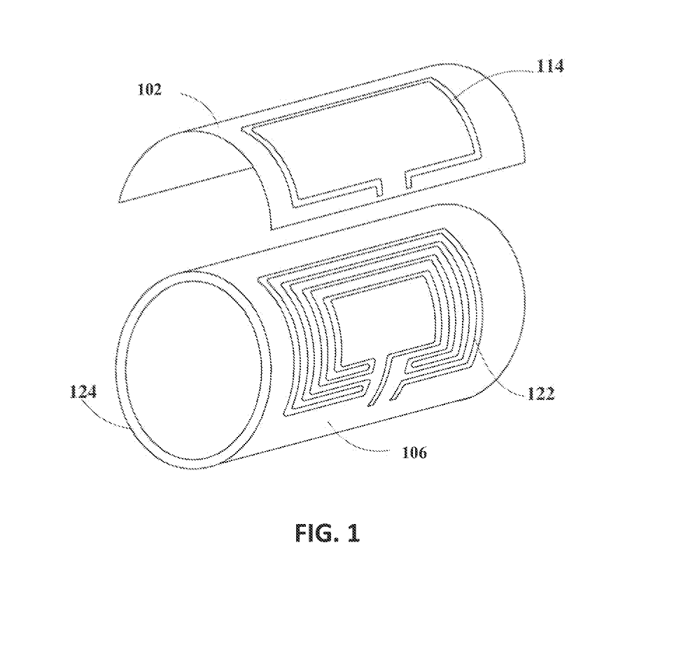

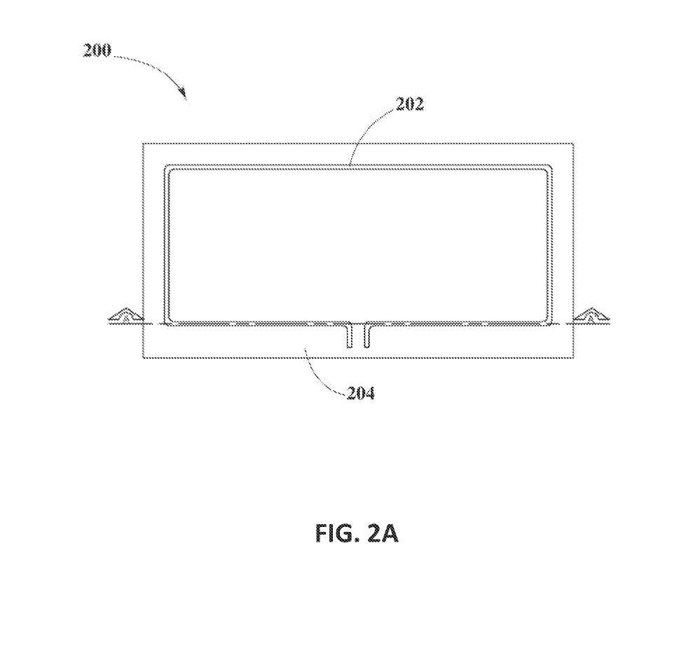

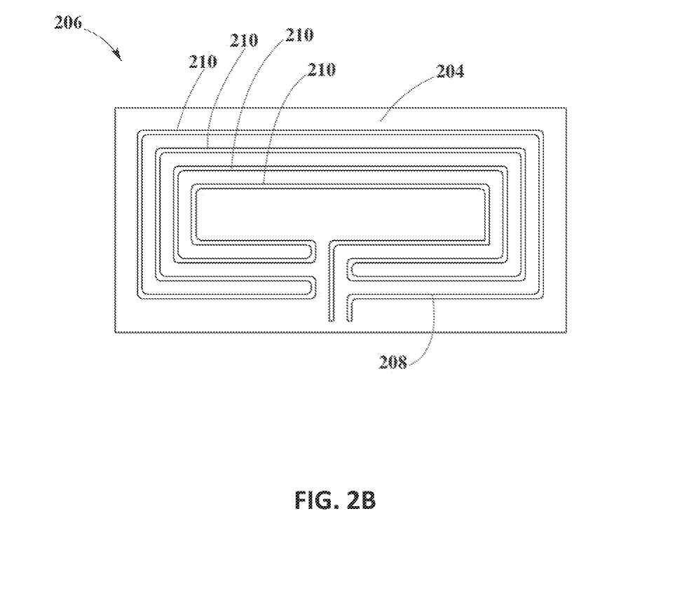

FIG. 1 is an illustration of an isometric view of a flexomaster according to embodiments of the present disclosure. FIG. 1 illustrates flexomaster patterns 102 and 106. In an embodiment, a top flexomaster 102 is mounted on the roll 124 and used in conjunction with a printing system, for example a metered printing system, to print the transparent single loop antenna circuitry 114 on the top surface of a flexible substrate such as pictured in FIG. 2A. The bottom flexomaster 106 is employed to print the transparent multiple loops antenna circuitry 122, which may also be referred to as the second or bottom pattern, comprising a plurality of loops on the bottom surface of the transparent flexible substrate. It is understood that the use of the words “top” and “bottom” herein is to reflect two different sides of a substrate and may be used interchangeably with “first” and “second,” and are not necessarily used in reference to the orientation of a substrate or final product. In an embodiment, this circuitry 122 may be similar to the circuitry pattern discussed below in FIG. 2B. In an embodiment, the flexomaster 102 and the flexomaster 106 are separately patterned flexoblanks that are each disposed on a different roll.

In this embodiment, the rollers such as the roller 124 may be arranged in series wherein the first pattern created by 114 is printed on the top surface of a circuit and the multiple loop antenna circuitry pattern 122 is printed on the bottom surface opposite of the first pattern 114. In an alternate embodiment, the rollers may be arranged such that the first pattern and the second pattern are printed by two different flexomasters on two different rolls and both patterns are printed on one substrate wherein the first pattern 114 is printed on the top (first) surface and the second pattern 122 is printed on the bottom (second) surface. While the example of RF antennas are provided herein, this method may also be applied to the manufacture of touch screen sensors and other high resolution conductive patterns where a single substrate or multiple substrates may be printed and assembled. In this example, the printing may occur simultaneously or in series as part of an in-line process. In another example, at least one of the top pattern or the bottom pattern is formed by a plurality of flexoplates disposed on a plurality of rolls. This may occur, for example, because the desired end pattern is designed with varying transitions, dimensions, and geometries that may make it appropriate to use more than one ink, which would then mean that more than one roll may be used. In another example, multiple rolls may be used to create one pattern because the pattern geometry, transitions, or dimensions are more uniformly printed in stages.

The height of the printed conductive lines in both the transparent single loop antenna circuitry 114 and the transparent multiple loops antenna circuitry 122 may vary from 100 nm-microns to 7 microns, while the distance between each pair of conductive lines might vary from 10 microns to 5 mm. The height as used herein refers to the distance between the substrate and the top of the printed pattern. The thickness of the material layer employed to create a master for the top flexomaster 102 and the bottom flexomaster 106 may range between 0.5 mm and 3.00 mm. In some embodiments, the flexomaster 106 may be an offset flexomaster which is backed on one side by a metallic siding which may be as thin as 0.1 mm.

FIGS. 2A and 2B are illustrations of top views of planar dipole transparent RF antenna structures according to embodiments of the present disclosure. In FIG. 2A, a planar dipole transparent RF antenna structure 200 may be designed for radiating or receiving wireless electromagnetic signals, as required in telecommunication applications. The RF antenna structure 200 may comprise a planar, dipole transparent single loop rectangular antenna 202 disposed on a transparent, flexible substrate 204. This type of antenna design exhibits a conductive line width that may vary from about 1 micron to about 30 microns, representing a dimension range that may produce a transparent effect to the naked eye, depending to the distance from the user. The printed micro electrodes (line or lines) of the transparent single loop rectangular antenna 202 may exhibit a light transmission efficiency of about 60%; and alternatively 90% or greater. The conductive electrodes might be constructed of gold plated copper, silver plated copper, or nickel plated copper, to provide passivation for corrosion resistance of copper that does not require chemical etching.

The resistivity of the printed electrode on the transparent single loop rectangular antenna 202 may range from about 0.005 micro Ohms per square to about 500 Ohms per square, while the length of the printed electrode may vary from about 0.01 m to about 1 m, depending on the frequency range which may also vary from about 125 KHz to about 25 GHz. The transparent RF antenna structure 200 may exhibit an omnidirectional radiation pattern according to desired the application. The impedance for RF antennas is given by the shape of the antenna, the type of material used, and changes on the environment.

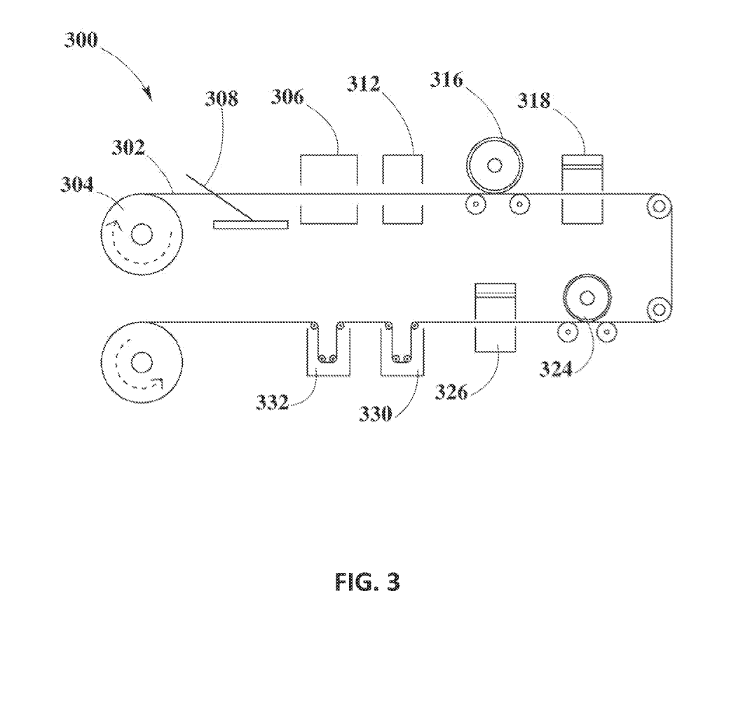

In general, materials that may be used for the transparent flexible substrate 102 include polyethylene terephthalate (PET) film, polycarbonates, and polymers. Specifically suitable materials for the transparent flexible substrate 102 may include the DuPont/Teijin Melinex 454 and DuPont/Teijin Melinex ST505, the latter being a heat stabilized film specially designed for processes where heat treatment is involved and where dimensional changes are not acceptable for the process. The transparent flexible substrate 102 may exhibit a thickness between 5 and 500 microns, with a preferred thickness between 100 microns and 200 microns. A detailed method of manufacturing transparent antenna circuits using roll to roll process is depicted in FIG. 3 and described herein.

The transparent RF antenna structure 200 might be designed in any pattern geometry, or array of antenna patterns, that can be adjusted individually to suit different frequencies or channels to receive or transmit terrestrial broadcasting as well as satellite broadcasting and radio signals, required for telecommunication application. In other embodiments, the transparent RF antenna structure 200 may be used along with reflective elements to increase the directivity of the radiation pattern.

FIG. 2B is an illustration of a multi-loop antenna structure according to embodiments of the present disclosure. The multi-loop antenna structure 206 comprises a pattern 208 that comprises a plurality of loops 210. In an embodiment, the plurality of loops may also be referred to as a loop array and the features may be described as concentric even if they are formed by a single, continuous, line. In an embodiment, the features may be rectangular in shape. In alternate embodiments, the features may be circular, square, triangular, or a combination thereof and the features may be referred to as loops regardless of the geometric shape or number of individual lines used. The pattern 208 may be printed on the bottom (second) side of the substrate 204. In an alternate embodiment, the pattern 208 may comprise contiguous lines.

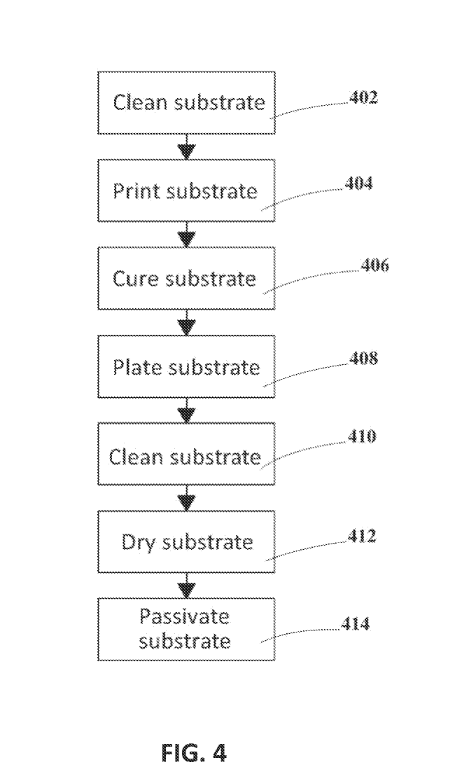

FIG. 3 is an embodiment of a system used to manufacture high resolution conducting patterns according to embodiments of the present disclosure. FIG. 4 is a flowchart of a method of manufacturing high resolution conducting patterns according to embodiments of the present disclosure. A transparent flexible substrate 302 in system 300, pictured here as a side-view along the process, is disposed on unwind roll 304 in a roll-to-roll handling process. It is appreciated that the term transparency as used herein may refer to structures with printed electrodes were the amount of light transmission is greater than about 60%, and the substrate may be any material that may be used as a base on which to print integrated circuitries, for example, polyethylene terephthalate (PET) film, polycarbonate, and polyethylene naphthalate (PEN). Materials for transparent flexible substrate may include the Du Pont/Teijin Melinex 454, and Du Pont/Teijin Melinex ST505, the latter being a heat stabilized film specially designed for processes where heat treatment is involved, this flexible substrate may exhibit a thickness between 5 and 500 microns, with a preferred thickness between 50 microns and 200 microns. The speed of the machine used in the process may vary from about 20 ft/m to about 750 ft/m. In some embodiments, a speed of about 50 ft/m to about 200 ft/m may be suitable. In some embodiments, alignment mechanism 308 is used to ensure that the substrate 302 is properly aligned with respect to the in-line process. The substrate 302 may be cleaned at block 402 at first cleaning station 306 that may comprise a high electric field ozone generator or corona plasma module employed to remove impurities, for example oils or grease from the transparent flexible substrate. In some embodiments, the transparent flexible substrate may then undergo a second cleaning at second cleaning station 312, which may be a web cleaner, for example, an adhesive tape. The substrate 302 which comprises a first (top) and a second (bottom) side may then have the first side printed at block 404 at printing station 316. At the first printing station 116, a high resolution printed pattern (HRP) is printed at block 404 by a first master plate that is in proximity to an ultraviolet curable polymer ink that might have a viscosity between about 200 centipoise (cps) and about 2000 centipoise (cps). In some embodiments, this high resolution conducting pattern might be conformed by conductive electrodes, a single loop or a plurality of loops, having a line width for each of the plurality of lines of the pattern between about 1 micron and about 30 microns. The structure may be considered transparent if the structure has greater than about 60% to about 90% light transmission.

The ink used at the first printing station may comprise acrylic monomer resin material doped with palladium acetate. The palladium acetate may be, for example, at a concentration of between about 1 wt. % to about 20 wt. %, preferably 1 wt. %-5 wt. %, of the acrylic monomer resin and may serve as a plating catalyst that is activated trough through ionizing radiation curing at block 406 at a first curing station 318. The curing at block 406 at curing station 318 may comprise a broad spectrum ultraviolet radiation curing with target intensity from about 0.5 mW/cm²-200 mW/cm² or higher. It is appreciated that FIG. 4 depicts curing the substrate at block 406 and that this curing at block 406 may comprise one type of curing using one piece of equipment or a plurality of types of curing that is performed in multiple steps which may occur after each pattern is printed or after both patterns are printed as discussed in more detail below. The UV radiation wave length may be from about 250-600 nm, and, preferably, may be between 365 nm to about 435 nm. This UV exposure causes two steps to occur simultaneously, the curing (polymerization) of the acrylic resin and the dissociation of the palladium acetate to palladium metal nano-particles, which form the seed layer for electroless plating of Cu, Ni or other metals. In some embodiments depending on ink composition and dimensions of printed patterns, in addition to UV, the process might consist of a heating module that applies heat within a temperature range of about 20° C. to about 130° C.

In some embodiments, a second pattern is printed at block 404 at second printing station 324. The second pattern may be cured at second curing station 326 in a similar fashion as first curing at first curing station 318. The second pattern may be printed on the second side substrate 302, or adjacent to the first pattern on the first side, or on a substrate other than substrate 302. It is appreciated that both printing stations 316 and 324 may have varied configurations. Both patterns may be printed at the same time at block 404 using both printing stations 316 and 324. Alternatively, not shown in FIG. 4 but as shown in FIG. 3, the second printing station 324 prints the second pattern subsequent to the first pattern being printed at first printing station 316 and cured at first curing 318.

In an embodiment, if the pattern printed at 316 or 324 comprises varying dimensions, transitions, and complexities of its geometry, the first or the second pattern, or both, the printing process may be adjusted to account for these aspects of one or both patterns. In another embodiment, printing stations 316 and 324 may be arranged such that the first pattern is printed on the first surface of the substrate 302 and the second pattern is created on the bottom side of the substrate 302 either simultaneously or in series in the in-line process. In this example, one substrate is patterned with two patterns, which may be different in geometry and may have been printed in different inks. In another embodiment, printing stations 316 and 324 may be arranged wherein the first pattern is printed on the first side of the substrate 302 and the second pattern is printed on the first side of substrate 302 adjacent to the first pattern. In another embodiment, at least one of the first of the second printing stations 316 and 324 comprise more than one flexoplate disposed on more than one roll as discussed in FIG. 1. This may occur, for example, because the desired end pattern is designed with varying transitions, dimensions, and geometries that may make it appropriate to use more than one ink, which would then mean that more than one roll may be used. In another example, multiple rolls may be used to create one pattern because the pattern geometry, transitions, or dimensions are more uniformly printed in stages, or because the multiple roll process per pattern may allow higher run speeds for the inline process.

Subsequent to printing, the patterns printed at 316 and 324 are plated, for example, by electroless plating 408. Electroless plating 408 at plating station 330 may be well suited for parts with complex geometries and/or many features, like those exhibited by printed transparent antenna patterns circuitries. During electroless plating at plating station 330, a conductive material such as copper (Cu) is disposed on the pattern. In some embodiments other conductive material such as silver (Ag), nickel (Ni), or aluminum (Al) may be used. The plating occurs in a fluid medium comprising the conductive material at a temperature range between about 20° C. and about 90° C. In an embodiment, the same conductive material may be used on the patterns printed at 316 and 324, and in another embodiment different conductive materials may be used on the patterns. The activated pattern(s) attract the conductive material to form a high resolution conducting pattern (HRCP). In certain instances, the liquid medium is at about 80° C., for example, depending on the metal therein. In one example, copper may be at a temperature from 35° C.-45° C., and in another example, nickel may be between 65° C.-80° C. The deposition rate may be between about 10 nm to about 200 nm per minute, with a final thickness achieved of about 10 nm-5000 nm (0.001 micron-5 microns. In an alternate example, the final thickness achieved by plating may be from about 10,000 nm-100,000 nm (10 microns-100 microns). The thickness of the plating on the pattern, which may also be referred to as the thickness of the plated pattern, may depend on the plating solution temperature and the speed of the web which may be varied according to the application. The electroless plating at the plating station does not require the application of electrical current and only plates the patterned areas containing a plating catalyst that were previously activated through ionizing ultraviolet radiation curing exposure. The plating thickness may be more easily controllable and therefore more uniform compared to electroplating due to the absence of electric fields.

After electroless plating, both patterns, may go through a washing process, which may also be referred to as another cleaning 410, at a wash station 332 which may be a dip or a spray (not pictured) station. The dip wash station 332 comprises submerging the patterns plated at plating station 330 into a cleaning tank that contains water at room temperature. The patterns may be subsequently dried 412 a drying station (not pictured) by applying air at room temperature. In some embodiments, in order to protect the conductive material of the RF antenna circuitries against corrosion, a passivation station (not shown in FIG. 3) may be used to passivate 414 the substrate and may be a pattern spray added after drying to prevent any undesired reaction between the conductive materials and water.

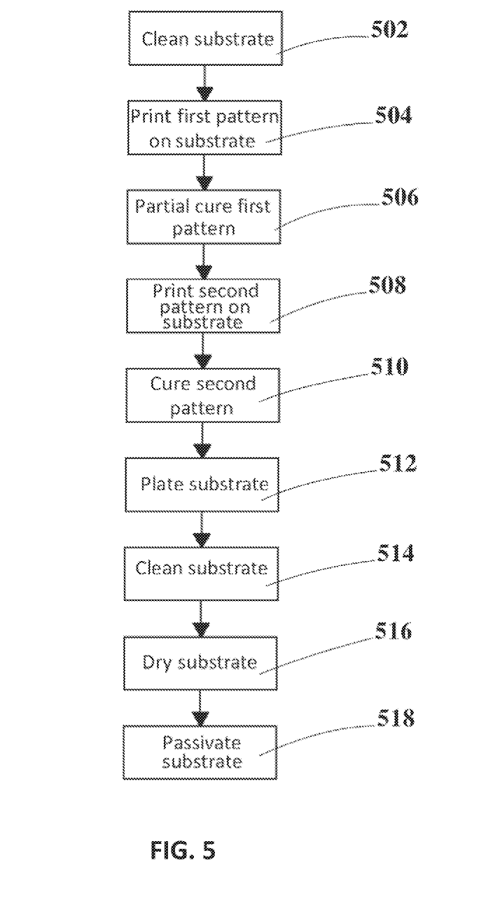

FIG. 5 a flowchart of a method of manufacturing high resolution conducting patterns according to embodiments of the present disclosure. In this embodiment, the substrate is cleaned at block 502 in a similar fashion to that described in FIG. 4 at block 402. It is appreciated that the method in FIG. 5 may be performed using equipment similar to the equipment disclosed in FIG. 3 and discussed above.

A first pattern, for example a first single or multiple antenna loop array, is then printed on a first side of a substrate at block 504. The first pattern is then cured at block 506 by, for example, a UV curing. Preferably, the curing at block 506 is a partial cure that is performed in order to solidify, cure, and dissociate the catalyst enough to hold the first pattern in place on the first side of the substrate while a second pattern is printed on a second side of the substrate at block 508. In an embodiment, the entire curing range for the substrate which may be referred to as the UV energy is equal to the time of exposure to the curing source multiplied by the power density. The UV energy for a full cure may range from 1 mJ/cm²-1000 mJ/cm². A partial cure may be a cure performed from 1%-99.99% of this range, depending upon what a full cure for the same application would measure. After the second pattern is printed at block 508, the second pattern is cured at block 510. The curing stage at block 510 may be sufficient enough to cure both the first and the second pattern, though it is appreciated that the base resins in the ink may only cure (dissociate) 90% under UV curing, whether the UV curing is done in a single stage or multiple stages. The remaining 10% of the curing in those embodiments may be achieved by a thermal cure or by allowing the UV-cured pattern or patterns to sit at room temperature for 18-24 hours. This stepped curing may be used so that the substrate is not over-cured, because over-curing could lead to the substrate to embrittle or otherwise deteriorate which may lead to a failure of the component, scrap in the process, or a combination of both. In that embodiment, the “light” or “baby” curing at curing station 318 is performed to hold the first pattern in place so that the second pattern can be printed and then both patterns cured to complete the dissociation of the catalytic compound, for example, the organometallic, in the ink. Subsequent to curing, the substrate may be plated at block 512 in a similar fashion to the electroless plating discussed above in FIG. 4 at block 408. The plated substrate may then undergo another cleaning at block 514, drying at block 516, and passivation at block 518, which may be similar to blocks 410, 412, and 414 in FIG. 4

While exemplary embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the examples disclosed herein are possible and are within the scope of the invention. Accordingly, the scope of protection is not limited by the description set out above, but is only limited by the claims which follow, that scope including all equivalents of the subject matter of the claims.

What is claimed:

1. A method of flexographically printing an RFID antenna comprising:
printing a first antenna loop array on a first side of a substrate, wherein printing the first antenna loop array comprises using an ink and a first flexomaster, wherein the ink comprises an acrylic monomer resin and a catalyst, wherein the catalyst is at a concentration from 1 wt. %-20 wt. %, and wherein the catalyst comprises a plurality of organometallic particles;
curing the substrate by dissociating the catalyst in the ink.

2. The method of claim 1, further comprising printing a second antenna loop array on a second side of the substrate, wherein printing the second antenna loop array comprises using the ink and a second flexomaster.

3. The method of claim 1, wherein the first antenna loop array comprises a single antenna loop, and wherein the second antenna loop array comprises a plurality of antenna loops.

4. The method of claim 1, wherein the plurality of organometallic particles are between 10-500 nm in diameter.

5. The method of claim 1, wherein the catalyst is at a concentration between 1 wt. %-5 wt. %.

6. The method of claim 1, wherein the plurality of organometallic particles are an organometallic acetate comprising one of palladium acetate, rhodium acetate, platinum acetate, copper acetate, nickel acetate, or combinations thereof.

7. The method of claim 1, wherein the plurality of organometallic particles are an organometallic oxalate comprising one of palladium oxalate, rhodium oxalate, platinum oxalate, copper oxalate, nickel oxalate, or combinations thereof.

8. The method of claim 1, further comprising plating the substrate using electroless plating, wherein a conductive material is deposited on the first antenna loop array and the second antenna loop array.

9. The method of claim 8, wherein the conductive material comprises copper (Cu), nickel (Ni), aluminum (Al), silver (Ag), gold (Au), palladium (Pd), or alloys and combinations thereof.

10. The method of claim 2, further comprising simultaneously curing the first antenna loop array and the second antenna loop array.

11. The method of claim 2, wherein the first antenna loop array and the second antenna loop array are printed simultaneously.

12. A method of flexographically printing an RFID antenna comprising:
printing a first antenna loop array on a first side of a substrate using an ink and a first flexomaster;
partially curing the first antenna loop array;
printing a second antenna loop array on a second side of the substrate using the ink and a second flexomaster; and
completely curing the second antenna loop array;
wherein the ink comprises an acrylic monomer resin and a catalyst, wherein the catalyst is at a concentration below 6%, and wherein the catalyst comprises a plurality of organometallic particles.

13. The method of claim 12, wherein each particle of the plurality of organometallic particles are 10 nm-500 nm in diameter.

14. The method of claim 12, wherein the plurality of organometallic particles are an acetate and are one of palladium acetate, rhodium acetate, platinum acetate, copper acetate, nickel acetate, or combinations thereof.

15. The method of claim 12, wherein the plurality of organometallic particles are an oxalate and are one of palladium oxalate, rhodium oxalate, platinum oxalate, copper oxalate, nickel oxalate, or combinations thereof.

16. The method of claim 12, further comprising plating the substrate by using electroless plating, wherein a conductive material is deposited on the first printed pattern and the second printed pattern, and wherein the conductive material comprises copper (Cu), nickel (Ni), aluminum (Al), silver (Ag), gold (Au), palladium (Pd), or alloys and combinations thereof.

17. The method of claim 16, wherein the first and the second antenna loop arrays have a resistivity of 0.005 micro Ohms per square to about 500 Ohms per square subsequent to plating.

18. A method of printing a high resolution conductive pattern comprising:
flexographically printing a first pattern comprising a first plurality of lines on a first substrate using a first flexomaster and an ink comprising an acrylic monomer resin and a catalyst;
flexographically printing a second pattern comprising a second plurality of lines using a second flexomaster and the ink, wherein each line of the first plurality of lines and each line of the second plurality of lines are 1-25 microns wide; and
curing the first and the second patterns.

19. The method of claim 18 wherein the first and the second patterns have a resistivity of 0.005 micro Ohms per square to about 500 Ohms per square subsequent to curing.

20. The method of claim 18 wherein the catalyst is one of palladium, copper, organometallic acetate, organometallic oxalate, or combinations thereof.

21. The method of claim 18, wherein the catalyst is at a concentration in the ink between 1 wt %-20 wt %.

22. The method of claim 18, wherein the catalyst is at a concentration in the ink between 1 wt %-5 wt %.

23. The method of claim 18, wherein the catalyst is an organometallic oxalate and the organometallic oxalate is one of palladium oxalate, rhodium oxalate, platinum oxalate, copper oxalate, nickel oxalate, or combinations thereof.

24. The method of claim 18, wherein the catalyst is an organometallic acetate and the organometallic acetate is one of palladium acetate, rhodium acetate, platinum acetate, copper acetate, nickel acetate, or combinations thereof.

25. The method of claim 18, further comprising electroless plating by depositing conductive material on the first printed pattern and the second printed pattern, wherein the conductive material comprises copper (Cu), nickel (Ni), aluminum (Al), silver (Ag), gold (Au), palladium (Pd), or alloys and combinations thereof.

26. The method of claim 18, wherein flexographically printing the second pattern comprises flexographically printing the second pattern on one of a second substrate, a side opposite the first pattern on the first substrate, or adjacent to the first pattern on the first substrate.
